(19) United States
(12) Patent Application Publication
(10) Pub. No.: US 2026/0155668 A1
(43) Pub. Date: Jun. 4, 2026

(54) FUEL CELL APPARATUS

(71) Applicants: HYUNDAI MOTOR COMPANY, Seoul (KR); KIA CORPORATION, Seoul (KR)

(72) Inventors: Woo Young Lee, Hwaseong-si (KR); Yoon Tae Kim, Hwaseong-si (KR); Jong Jun Lee, Hwaseong-si (KR); Hyeon Ju Jeong, Hwaseong-si (KR); Jae Ho Kim, Hwaseong-si (KR); Sae Kwon Chang, Hwaseong-si (KR); Joo Seung Lee, Hwaseong-si (KR)

(73) Assignees: HYUNDAI MOTOR COMPANY, Seoul (KR); KIA CORPORATION, Seoul (KR)

(21) Appl. No.: 19/193,345

(22) Filed: Apr. 29, 2025

(30) Foreign Application Priority Data
Nov. 29, 2024 (KR) 10-2024-0175359

(51) Int. Cl. H02J 7/00; H01M 8/04858; H01M 16/00

(52) U.S. Cl. CPC H02J 7/933; H01M 8/0488; H01M 8/04888; H01M 16/006

(57) ABSTRACT

A fuel cell apparatus includes a fuel cell; a voltage level conversion unit configured to boost stack voltage generated by the fuel cell in response to a first control signal; a main battery configured to store boosted voltage output from the voltage level conversion unit; an auxiliary unit configured to be driven by auxiliary power generated using voltage stored in a sub-battery and to generate the first control signal; and a pre-charging unit configured to pre-charge the voltage level conversion unit using pre-charging voltage generated through the auxiliary unit.

### CROSS-REFERENCE TO RELATED APPLICATION

This application claims the benefit of and priority to Korean Patent Application No. 10-2024-0175359, filed on Nov. 29, 2024, the entire contents of which are incorporated herein by reference.

### TECHNICAL FIELD

The present disclosure relates to a fuel cell apparatus.

### BACKGROUND

In a general fuel cell apparatus, the voltage of a cell stack of a fuel cell is lower than the voltage stored in a high-voltage battery. Therefore, a high-voltage boost DC/DC converter (or a fuel cell DC/DC converter (FDC)) is used in order to boost the voltage of the cell stack to the voltage level of the high-voltage battery. In addition, a power distribution unit is used in order to distribute various types of power to parts of the fuel cell apparatus.

Before the fuel cell apparatus operates, the cell stack of the fuel cell does not generate voltage and thus is in a zero-voltage state. The FDC and the power distribution unit are also in a zero-voltage state because voltage is completely discharged therefrom before operation of the fuel cell apparatus.

Meanwhile, energy corresponding to a voltage of several hundred volts is stored in the high-voltage battery. Accordingly, when operation of the fuel cell apparatus commences, a high level of inrush current is instantaneously applied from the high-voltage battery to an output capacitor of the FDC, which may lead to burning of a main relay or the like. Therefore, research with the goal of solving the above problem is underway.

The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

The present disclosure is directed to a fuel cell apparatus that substantially obviates one or more problems associated with limitations and disadvantages of the related art.

The present disclosure provides a fuel cell apparatus capable of implementing a pre-charging function with a simple configuration.

However, the aspects described above are merely illustrative and do not encompass all features of the present disclosure. Additional features and advantages will be apparent to those of ordinary skill in the art in view of the present disclosure.

Additional advantages, objects, and features of the present disclosure are set forth in part in the present disclosure. Additional advantages, objects, and features of the present disclosure in part should become apparent to those having ordinary skill in the art upon examination of the present disclosure or may be learned from practice of the present disclosure. The objectives and other advantages of the present disclosure may be realized and attained by the structure particularly pointed out in the written description and claims hereof as well as the appended drawings.

According to an embodiment, a fuel cell apparatus may include a fuel cell. The fuel cell apparatus may further include a voltage level conversion unit configured to boost stack voltage generated by the fuel cell in response to a first control signal. The fuel cell apparatus may further include a main battery configured to store boosted voltage output from the voltage level conversion unit. The fuel cell apparatus may further include an auxiliary unit configured to be driven by auxiliary power generated using voltage stored in a sub-battery and to generate the first control signal. The fuel cell apparatus may further include a pre-charging unit configured to pre-charge the voltage level conversion unit using pre-charging voltage generated through the auxiliary unit.

In an example, the fuel cell apparatus may further include a main switching unit connected between the voltage level conversion unit and the main battery and configured to perform a switching operation in response to a second control signal. The fuel cell apparatus may further include a main controller configured to generate the second control signal, and the main controller may control the pre-charging unit.

In an example, the voltage level conversion unit may include an input capacitor connected between a positive output terminal and a negative output terminal of the fuel cell. The voltage level conversion unit may further include an inductor including a first end connected to the positive output terminal. The voltage level conversion unit may further include a first diode including an anode connected to a second end of the inductor. The voltage level conversion unit may further include an output capacitor connected between a cathode of the first diode and the negative output terminal. The voltage level conversion unit may further include a semiconductor switch connected between the anode of the first diode and the negative output terminal and configured to perform a switching operation in response to the first control signal.

In an example, the auxiliary unit may include a buck converter configured to step down voltage stored in the sub-battery to first and second levels. The auxiliary unit may further include an insulated converter configured to boost voltage having the first level to turn-on voltage required to drive the voltage level conversion unit and to the pre-charging voltage. The auxiliary unit may further include a driving unit configured to be driven in response to voltage having the second level and to generate the first control signal using the turn-on voltage.

In an example, the insulated converter may include a multi-output transformer including a first output terminal configured to output the turn-on voltage obtained by boosting the voltage having the first level and a second output terminal configured to output the pre-charging voltage obtained by boosting the voltage having the first level. The insulated converter may further include a second diode including an anode connected to the first output terminal of the multi-output transformer. The insulated converter may further include a first capacitor connected to a cathode of the second diode and configured to be charged with the turn-on voltage.

In an example, the pre-charging unit may include an auxiliary switching unit including an end connected to the second output terminal of the multi-output transformer and configured to perform a switching operation in response to a third control signal. The pre-charging unit may further include a third diode including an anode connected to the other end of the auxiliary switching unit and a cathode connected to the cathode of the first diode. The pre-charging unit may further include a second capacitor connected between the cathode of the third diode and the negative output terminal. The main controller may generate the third control signal.

According to another embodiment, a method of controlling the above-described fuel cell apparatus may include outputting a boosted voltage through a first output terminal of a multi-output transformer as a turn-on voltage for charging a first capacitor. The method may further include outputting a boosted voltage through a second output terminal of the multi-output transformer as a pre-charging voltage. The method may further include switching off a main switching unit connected between a voltage level conversion unit and a main battery and switching on an auxiliary switching unit including an end connected to the second output terminal of the multi-output transformer. The method may further include pre-charging an output capacitor connected between a cathode of a first diode and a negative output terminal of a fuel cell, by using a pre-charging voltage charged in a second capacitor. The method may further include switching off the auxiliary switching unit. The method may further include switching on the main switching unit. The method may further include driving the fuel cell.

In an example, the method may further include stopping operation of an insulated converter including the multi-output transformer.

It should be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings are included to provide a further understanding of the present disclosure and are incorporated in and constitute a part of the present disclosure. The accompanying drawings illustrate embodiment(s) of the present disclosure and together with the descriptions serve to explain the principle of the present disclosure. In the drawings:

FIG. 1 is a block diagram of a fuel cell apparatus according to an embodiment;

FIG. 2 is a block diagram of a sub-battery and an auxiliary unit shown in FIG. 1 according to an embodiment;

FIG. 3 is a circuit diagram of the fuel cell apparatus shown in FIG. 1 according to an embodiment;

FIG. 4 shows a method of controlling the fuel cell apparatus according to an embodiment; and

FIG. 5 is a circuit diagram of a fuel cell apparatus according to a comparative example.

### DETAILED DESCRIPTION OF THE DISCLOSURE

The present disclosure is now described more fully hereinafter with reference to the accompanying drawings, in which various embodiments are shown. The examples, however, may be embodied in many different forms and should not be construed as being limited to the embodiments set forth herein. Rather, these embodiments are provided so that the present disclosure can be more thorough and complete and can more fully convey the scope of the present disclosure to those having ordinary skill in the art.

It should be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish one subject or element from another subject or element, without necessarily requiring or involving any physical or logical relationship or sequence between the subjects or elements. When a controller, apparatus, module, component, device, element, or the like of the present disclosure is described as having a purpose or performing an operation, function, or the like, the controller, apparatus, module, component, device, element, or the like should be considered herein as being “configured to” meet that purpose or to perform that operation or function. Each controller, apparatus, module, component, device, element, and the like may separately embody or be included with a processor and a memory, such as a non-transitory computer readable media, as part of the apparatus.

Hereinafter, a fuel cell apparatus 100 according to an embodiment is described with reference to the accompanying drawings.

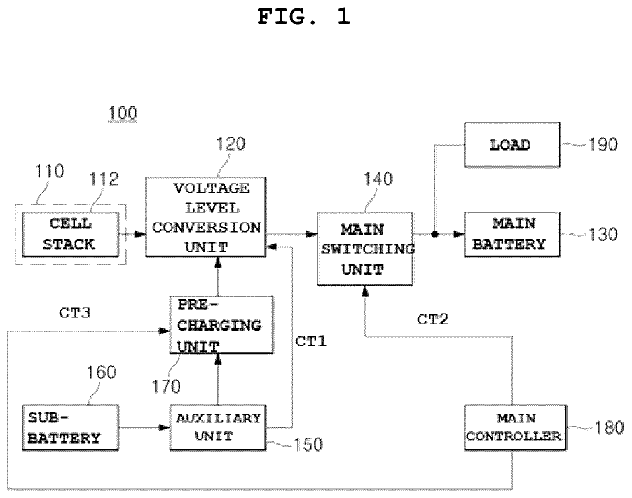

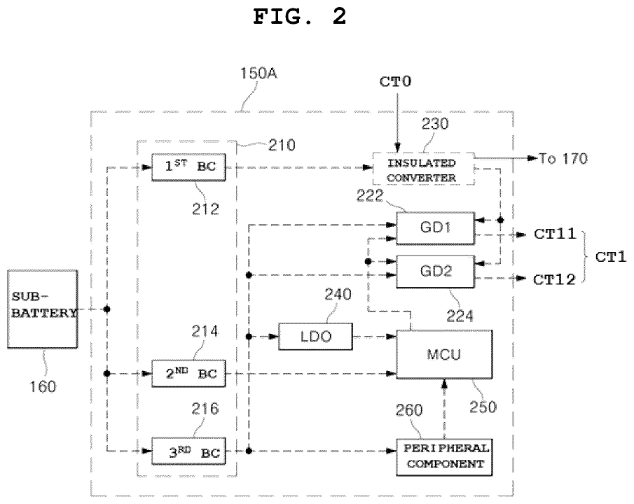

FIG. 1 is a block diagram of a fuel cell apparatus 100 according to an embodiment. FIG. 2 is a block diagram of a sub-battery 160 and an auxiliary unit 150 shown in FIG. 1 according to an embodiment.

The fuel cell apparatus 100 shown in FIG. 1 may include a fuel cell 110, a voltage level conversion unit 120, a main battery (or a high-voltage battery) 130, an auxiliary unit 150, and a pre-charging unit 170. In addition, the fuel cell apparatus 100 may further include a main switching unit 140, a sub-battery 160, and a main controller 180. In addition, the fuel cell apparatus 100 may further include a load 190.

The fuel cell 110 may include a plurality of unit fuel cells stacked in at least one of a vertical direction or a horizontal direction. The unit fuel cell may be a polymer electrolyte membrane fuel cell (or a proton exchange membrane fuel cell) (PEMFC), which has been studied most extensively as a power source for driving fuel cell vehicles. However, the embodiments are not limited to any specific form, configuration, or appearance of the unit fuel cell.

The unit fuel cell included in the fuel cell 110 may include end plates (pressing plates or compression plates), current collectors, and a cell stack 112.

The cell stack 112 may include a plurality of unit cells stacked in the horizontal direction. Tens to hundreds of unit cells, for example, 100 to 400 unit cells, may be stacked to form the cell stack. The number of unit fuel cells included in the fuel cell 110 and the number of unit cells included in the cell stack of the unit fuel cell may be determined based on the intensity of power to be supplied from the fuel cell 110 to the load 190.

The end plates may be disposed at two opposite ends of the cell stack 112 and may support and fix the plurality of unit cells. In other words, one of the end plates may be disposed at one of the two opposite ends of the cell stack, and the other of the end plates may be disposed at the other of the two opposite ends of the cell stack.

In addition, the fuel cell 110 may further include a clamping member, which has a bar shape, a long bolt shape, a belt shape, or a rigid rope shape, to clamp the plurality of unit cells. For example, in each unit fuel cell, the clamping member serves to clamp the plurality of unit cells in the horizontal direction together with the end plates.

The voltage level conversion unit 120 may convert the level of the stack voltage generated by the fuel cell 110 in response to a first control signal CT1. In other words, the voltage level conversion unit 120 may boost the stack voltage and may supply the boosted voltage to the main battery 130 or the load 190. For example, the voltage level conversion unit 120 may include a high-voltage boost DC/DC converter (or a fuel cell DC/DC converter (FDC)).

The voltage level conversion unit 120 performs the operation of matching the stack voltage generated by the fuel cell 110 with the voltage stored in the main battery 130. For example, while the level of the stack voltage is about 100 V to about 200 V, the voltage level of the main battery 130 is about 600 V. Thus, the voltage level conversion unit 120 may operate as a type of boost converter that steps up the stack voltage to 600 V. In some cases, boost converters may be connected in parallel to implement the voltage level conversion unit 120.

The voltage across the positive output terminal PN and the negative output terminal NN of the fuel cell 110 corresponds to the stack voltage.

The main battery 130 serves to store the boosted voltage output from the voltage level conversion unit 120 and supply power required for the load 190.

The main controller 130 serves to control the operation of the voltage level conversion unit 120.

The load 190 may include an inverter and a motor. The inverter may be connected to the boosted voltage or the battery voltage, may convert DC voltage received from the voltage level conversion unit 120 into AC voltage in accordance with the driving state of the vehicle, and may output the AC voltage to the motor. The motor may operate in response to the AC voltage output from the inverter. In other words, the motor may rotate in response to the AC voltage for the motor received from the inverter and thus may perform the function of driving the fuel cell apparatus 100. For example, the motor may be a three-phase AC rotating device that includes a rotor in which permanent magnets are embedded. However, the embodiments are not limited to any specific form of the main output unit, the inverter, or the motor.

In addition, the fuel cell apparatus 100 may further include peripheral auxiliary devices (balance-of-plant (BOP)) and high-voltage components. Here, the BOP is an operating device for driving the fuel cell and includes a compressor, a cooling pump, and a hydrogen supplier.

The main battery 130 stores the boosted voltage output from the voltage level conversion unit 120.

The main switching unit 140 is connected between the voltage level conversion unit 120 and the main battery 130 and performs a switching operation in response to a second control signal CT2. The main controller 180 generates the second control signal CT2 and outputs the second control signal CT2 to the main switching unit 140.

The pre-charging unit 170 pre-charges the voltage level conversion unit 120 using pre-charging voltage generated through the auxiliary unit 150 in response to a third control signal CT3. To this end, the main controller 180 may generate the third control signal CT3 and may output the third control signal CT3 to the pre-charging unit 170.

The sub-battery 160 and the auxiliary unit 150 shown in FIG. 2 may be collectively referred to as an “auxiliary power supply unit”.

The auxiliary power supply unit shown in FIG. 2 may include a sub-battery 160 and an auxiliary unit 150A. The sub-battery 160 and the auxiliary unit 150A correspond to the sub-battery 160 and the auxiliary unit 150 shown in FIG. 1, respectively.

The auxiliary unit 150 is driven by auxiliary power generated using the voltage stored in the sub-battery 160, generates the first control signal CT1, and outputs the first control signal CT1 to the voltage level conversion unit 120.

The auxiliary unit 150A shown in FIG. 2 is merely given by way of example. The fuel cell apparatus 100 according to the embodiment is not limited to any specific configuration of the auxiliary unit 150.

The auxiliary unit 150A shown in FIG. 2 may include a buck converter 210, driving units 222 and 224 (GD1 and GD2), an insulated converter 230, a low dropout regulator 240 (LDO), a microcontroller unit 250 (MCU), and a peripheral component 260.

The buck converter (BC) 210 lowers the level of the voltage stored in the sub-battery 160 and outputs stepped-down voltage having the lowered level. For example, the buck converter 210 may include first to third BCs 212, 214, and 216. However, the embodiments are not limited thereto.

The first to third BCs 212 to 216 step down the voltage stored in the sub-battery 160 to different levels and output the stepped-down voltages. In other words, the voltage having a first level stepped down by the first BC 212 is output to the insulated converter 230, the voltage stepped down by the second BC 214 is output to the MCU 250, and the voltage having a second level stepped down by the third BC 216 is output to the peripheral component 260, the LDO 240, the GD1 222, and the GD2 224.

In response to a 0^{th} control signal CT0, the insulated converter 230 boosts the voltage having the first level output from the first BC 212 to turn-on voltage required to drive the voltage level conversion unit 120 and supplies the turn-on voltage to the GD1 222 and the GD2 224. In addition, the insulated converter 230 boosts the voltage having the first level to pre-charging voltage and outputs the pre-charging voltage to the pre-charging unit 170. To this end, the insulated converter 230 may be connected to the pre-charging unit 170.

The LDO 240 steps down the voltage having the second level output from the third BC 216 to voltage having a predetermined level and outputs the stepped-down voltage to the MCU 250.

The MCU 250 generates a pulse width modulated (PWM) signal using the voltage output from the second BC 214 and the voltage output from the LDO 240 and outputs the PWM signal to the GD1 222 and the GD2 224. To this end, the peripheral component 260 serves to assist in implementation of the function of the MCU 250. For example, the peripheral component 260 may include an operational amplifier (OPAMP), a comparator, or various logic elements.

The driving units 222 and 224 (GD1 and GD2) operate in response to the voltage having the second level output from the third BC 216 and generate the first control signal CT1 using the PWM signal received from the MCU 250 and the turn-on voltage received from the insulated converter 230. For example, when the voltage level conversion unit 120 shown in FIG. 1 is two-phase, the two driving units 222 and 224 (GD1 and GD2) may generate 1-1^{st} and 1-2^{nd} control signals CT11 and CT12 and may output the 1-1^{st} and 1-2^{nd} control signals CT11 and CT12 to the voltage level conversion unit 120, as shown in FIG. 2.

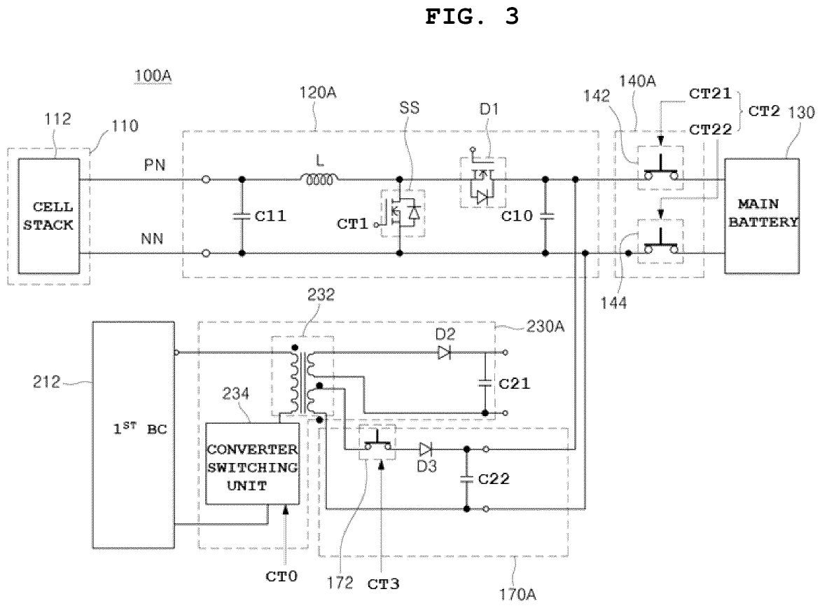

FIG. 3 is a circuit diagram of the fuel cell apparatus 100A shown in FIG. 1 according to an embodiment.

For convenience of description, illustration of the sub-battery 160, the load 190, and the main controller 180 shown in FIG. 1 is omitted in FIG. 3, and FIG. 3 shows only a portion of the auxiliary unit 150A shown in FIG. 2.

The fuel cell apparatus 100A shown in FIG. 3 may include a fuel cell 110, a voltage level conversion unit 120A, a main battery 130, a main switching unit 140A, a pre-charging unit 170A, a first BC 212, and an insulated converter 230A.

The fuel cell 110, the voltage level conversion unit 120A, the main battery 130, the main switching unit 140A, and the pre-charging unit 170A shown in FIG. 3 correspond to embodiments of the voltage level conversion unit 120, the main battery 130, the main switching unit 140, and the pre-charging unit 170 shown in FIG. 1, respectively. The first BC 212 and the insulated converter 230A shown in FIG. 3 correspond to embodiments of the first BC 212 and the insulated converter 230 shown in FIG. 2, respectively.

Referring to FIG. 3, the voltage level conversion unit 120A may include an input capacitor C11, an inductor L, a first diode D1, an output capacitor C10, and a semiconductor switch SS. The voltage level conversion unit 120 may also include a high-voltage boost DC/DC converter (or a fuel cell DC/DC converter (FDC)).

The input capacitor C11 may be connected to the input side of the voltage level conversion unit 120A, i.e., connected between the positive output terminal PN and the negative output terminal NN of the fuel cell 110.

The inductor L has an end connected to the positive output terminal PN.

The first diode D1 has an anode connected to the other end of the inductor L. For example, as illustrated in the drawings, the first diode D1 may be implemented in the form of a transistor. However, the embodiments are not limited to any specific form of the first diode D1.

The output capacitor C10 is connected between the cathode of the first diode D1 and the negative output terminal NN.

The semiconductor switch SS may perform a switching operation, i.e., may be switched on or off between the other end of the inductor L and the negative output terminal NN in response to the first control signal CT1. In other words, the semiconductor switch SS may be connected between the negative output terminal NN and the other end of the inductor L and may perform a switching operation in response to the first control signal CT1 applied to the gate. In other words, the semiconductor switch SS may have a gate connected to the first control signal CT1, a drain connected to the other end of the inductor L, and a source connected to the negative output terminal NN.

The semiconductor switch SS may be implemented as an insulated gate bipolar transistor (IGBT) or a field effect transistor (FET). For example, the semiconductor switch SS may be implemented as a transistor, as shown in FIG. 3.

Although the voltage level conversion unit 120 is illustrated in FIG. 3 as being one-phase, the embodiments are not limited thereto. In other words, the voltage level conversion unit 120 may be multi-phase. If, as shown in FIG. 3, the voltage level conversion unit 120 is one-phase, the control signal CT11 generated by the GD1 222 shown in FIG. 2 may be applied to the gate of the semiconductor switch SS as the first control signal.

The insulated converter 230A may include a multi-output transformer 232, a second diode D2, and a first capacitor C21.

The multi-output transformer 232 has multiple output terminals, i.e., first and second output terminals, as shown in the drawings.

The multi-output transformer 232 may boost the voltage having the first level output from the first BC 212 by K times and may output the boosted voltage through the first output terminal as the turn-on voltage. In addition, the multi-output transformer 232 may boost the voltage having the first level output from the first BC 212 by J times and may output the boosted voltage through the second output terminal as the pre-charging voltage. For example, when voltage having a first level of 10 volts is output from the first BC 212, voltage of 20 volts (K=2) may be output from the first output terminal of the multi-output transformer 232, and voltage of 600 volts (J=60) may be output from the second output terminal of the multi-output transformer 232.

The second diode D2 has an anode connected to the first output terminal of the multi-output transformer 232.

The first capacitor C21 is connected to the cathode of the second diode D2, is charged with the turn-on voltage, and supplies the charged turn-on voltage to the driving units 222 and 224 shown in FIG. 2. In addition, the insulated converter 230A may further include a converter switching unit 234 connected in series to the input terminal of the multi-output transformer 232. The converter switching unit 234 performs a switching operation in response to a 0^{th} control signal CT0. When the converter switching unit 234 is switched off in response to the 0^{th} control signal CT0, the insulated converter 230A stops operating. In this way, the operation of the insulated converter 230A may depend on the switching operation of the converter switching unit 234.

The main switching unit 140A may include 1-1^{st} and 1-2^{nd} switches (or relay elements) 142 and 144. The 1-1^{st} switch 142 performs a switching operation in response to a 2-1^{st} control signal CT21, and the 1-2^{nd} switch 144 performs a switching operation in response to a 2-2^{nd} control signal CT22. The second control signal CT2 including the 2-1^{st} control signal CT21 and the 2-2^{nd} control signal CT22 may be generated by the main controller 180 shown in FIG. 1.

The main controller 180 may use the main switching unit 140A in order to control transfer of the boosted voltage from the voltage level conversion unit 120 or 120A to the main battery 130, transfer of the voltage from the voltage level conversion unit 120 or 120A to the load 190, and transfer of the battery voltage from the battery 130 to the load 190.

The pre-charging unit 170A may include an auxiliary switching unit 172, a third diode D3, and a second capacitor C2.

The auxiliary switching unit 172 has an end connected to the second output terminal of the multi-output transformer 232 and performs a switching operation in response to the third control signal CT3. Here, the main controller 180 may generate the third control signal CT3 based on whether to perform pre-charging.

The third diode D3 has an anode connected to the other end of the auxiliary switching unit 172 and a cathode connected to the cathode of the first diode D1.

The second capacitor C2 is connected between the cathode of the third diode D3 and the negative output terminal NN.

The main controller 180 generates the third control signal CT3 and outputs the third control signal CT3 to the auxiliary switching unit 172.

Hereinafter, a method of controlling the fuel cell apparatus having the above-described configuration is described with reference to the accompanying drawings.

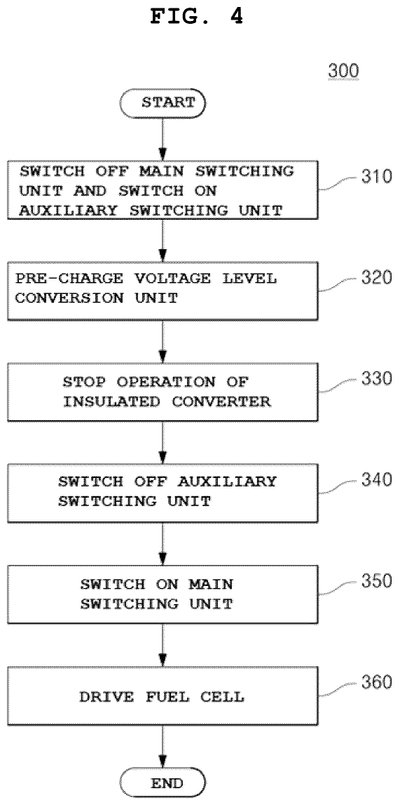

FIG. 4 shows a method 300 of controlling the fuel cell apparatus according to an embodiment.

A pre-charging mode is a mode that is performed before supplying main power to the main battery 130 or the load 190. In other words, when the main switching unit 140A is turned on, the level of the voltage output from the voltage level conversion unit 120A and the level of the voltage corresponding to the auxiliary power stored in the main battery 130 are not identical to each other. Thus, overcurrent occurs, which may lead to burning of an element such as the main switching unit 142.

For example, it is assumed that the voltage charged in the output capacitor C10 is 0 volts before the main switching unit 140A is switched on. In this case, the voltage charged in the output capacitor C10 increases rapidly from 0 volts to the level of the voltage stored in the main battery 130 as soon as the main switching unit 140A is switched on. Accordingly, a surge current is generated from the main battery 130 to the output capacitor C10, which may lead to burning of the main switching unit 140A and the voltage level conversion unit 120A.

In order to prevent this problem, the pre-charging mode is performed in order to make the level of the voltage output from the voltage level conversion unit 120A and the level of the voltage corresponding to the auxiliary power stored in the main battery 130 identical to each other. Then, the main switching unit 142 is switched on (or turned on).

In order to perform the pre-charging mode, the fuel cell apparatus is controlled as follows.

Referring to FIG. 3, in order to control the fuel cell apparatus 100A, the 1-1^{st} switch 142 of the main switching unit 140A is switched off, the 1-2^{nd} switch 144 is switched on, and the auxiliary switching unit 172 is switched on (step 310). Therefore, connection between the output capacitor C10 of the voltage level conversion unit 120A and the main battery 130 may be released, and the output capacitor C10 may be connected to the insulated converter 230A through the pre-charging unit 170A.

After step 310, the voltage level conversion unit 120A is pre-charged (step 320). Therefore, the output capacitor C10 is connected to the pre-charging unit 170A, and thus the voltage output from the second output terminal of the multi-output transformer 232 and charged to the second capacitor C2 is used as pre-charging voltage. Thus, the output capacitor C10 may be pre-charged. The output capacitor C10 is charged with the pre-charging voltage having the same level as the high-voltage battery voltage stored in the main battery 130.

After step 320, the operation of the insulated converter 230A is stopped (step 330). To this end, the converter switching unit 234 may be switched off using the 0^{th} control signal CT0.

After step 330, the auxiliary switching unit 172 is switched off (step 340). Therefore, connection between the voltage level conversion unit 120A and the insulated converter 230A may be released.

After step 340, the 1-1^{st} switch 142 of the main switching unit 140A is switched on (step 350).

After step 350, the fuel cell 110 is driven (step 360).

Hereinafter, a fuel cell apparatus according to a comparative example and the fuel cell apparatus according to the embodiment are described with reference to the accompanying drawings.

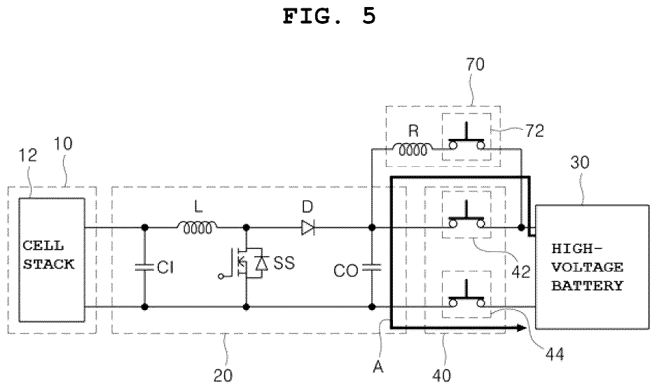

FIG. 5 is a circuit diagram of the fuel cell apparatus according to the comparative example.

The fuel cell apparatus according to the comparative example shown in FIG. 5 may include a fuel cell 10, an FDC 20, a high-voltage battery 30, a main switching unit 40, and a pre-charging unit 70.

The fuel cell 10, the FDC 20, the high-voltage battery 30, and the main switching unit 40 perform the same functions as the fuel cell 110, the voltage level conversion unit 120A, the main battery 130, and the main switching unit 140A according to the embodiment, respectively. Therefore, the cell stack 12 shown in FIG. 5 performs the same function as the cell stack 112 shown in FIG. 1.

In the fuel cell apparatus according to the comparative example shown in FIG. 5, current flows in the direction indicated by arrow A in the pre-charging mode. To this end, the first switch (or relay) 42 of the main switching unit 40 is switched off, and each of the second switch 44 and the pre-charging switch 72 is switched on.

Thereafter, the output capacitor C10 of the FDC 20 is pre-charged.

Thereafter, the first switch 42 of the main switch 40 is switched on, the pre-charging switch 72 is switched off, and then the cell stack 12 of the fuel cell 10 starts to operate.

In the fuel cell apparatus according to the comparative example described above, the pre-charging unit 70 that performs the pre-charging mode includes a pre-charging switch 72 and a resistor R. Here, because high-voltage battery current flows through the pre-charging switch 70 and the resistor R, the pre-charging switch 70 and the resistor R have disadvantages of high costs, large size, and heavy weight.

In contrast, the fuel cell apparatus according to the embodiment does not require the switch 70 and the resistor R for pre-charging, and thus costs, size, and weight thereof are reduced.

In addition, in the case of the comparative example, loss occurs in the pre-charging resistor R, and heat is generated therefrom. Thus, the efficiency of the fuel cell apparatus is reduced, and the costs, size, and weight thereof are increased due to application of a measure to dissipate resistance heat.

In contrast, because the embodiment does not require the resistor R, no additional loss occurs, the efficiency of the fuel cell apparatus may be increased, and the costs, size, and weight thereof may be reduced.

Because the voltage level conversion unit 120 does not operate during the pre-charging section among the sequences of start-up of the fuel cell apparatus, the auxiliary power supply unit 160 and 150A also does not operate. In this way, because the pre-charging function is performed using the auxiliary power supply unit during a time period during which the auxiliary power supply unit 160 and 150A does not operate, the output capacity of the auxiliary power supply unit does not need to increase for pre-charging.

The fuel cell apparatus 100 according to the embodiments described above may be applied to vehicles, aircraft, ships, stationary power generation systems, etc., but the present disclosure is not limited thereto.

As is apparent from the above descriptions, because the fuel cell apparatus according to the embodiment does not require a pre-charging resistor, no additional loss occurs, the efficiency of the fuel cell apparatus may be increased, and the costs, size, and weight thereof may be reduced.

However, the effects achievable through the present disclosure are not limited to the above-mentioned effects, and other effects not mentioned herein should be clearly understood by those having ordinary skill in the art from the present disclosure.

The above-described various embodiments may be combined with each other without departing from the scope of the present disclosure unless the above-described various embodiments are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to embodiments thereof, these embodiments are only proposed for illustrative purposes and do not restrict the present disclosure. It should be apparent to those having ordinary skill in the art that various changes in form and detail may be made without departing from the present disclosure. For example, respective configurations set forth in the embodiments may be modified and applied. Further, differences in such modifications and applications should be construed as falling within the scope of the present disclosure as defined by the appended claims.

What is claimed is:

1. A fuel cell apparatus, comprising:
a fuel cell;
a voltage level conversion unit configured to boost stack voltage generated by the fuel cell in response to a first control signal;
a main battery configured to store boosted voltage output from the voltage level conversion unit;
an auxiliary unit configured to be operated by auxiliary power generated using voltage stored in a sub-battery and to generate the first control signal; and
a pre-charging unit configured to pre-charge the voltage level conversion unit using a pre-charging voltage generated through the auxiliary unit.

2. The fuel cell apparatus according to claim 1, further comprising:
a main switching unit connected between the voltage level conversion unit and the main battery, the main switching unit being configured to perform a switching operation in response to a second control signal; and
a main controller configured to generate the second control signal,
wherein the main controller controls the pre-charging unit.

3. The fuel cell apparatus according to claim 2, wherein the voltage level conversion unit includes:
an input capacitor connected between a positive output terminal and a negative output terminal of the fuel cell;
an inductor including a first end connected to the positive output terminal;
a first diode including an anode connected to a second end of the inductor;
an output capacitor connected between a cathode of the first diode and the negative output terminal; and
a semiconductor switch connected between the anode of the first diode and the negative output terminal, the semiconductor switch being configured to perform a switching operation in response to the first control signal.

4. The fuel cell apparatus according to claim 3, wherein the auxiliary unit includes:
a buck converter configured to step down voltage stored in the sub-battery to a first level and a second level;
an insulated converter configured to boost voltage having the first level to turn-on voltage required to drive the voltage level conversion unit and to the pre-charging voltage; and
a driving unit configured to operate in response to voltage having the second level and to generate the first control signal using the turn-on voltage.

5. The fuel cell apparatus according to claim 4, wherein the insulated converter includes:
a multi-output transformer including:
a first output terminal configured to output the turn-on voltage obtained by boosting the voltage having the first level, and
a second output terminal configured to output the pre-charging voltage obtained by boosting the voltage having the first level;
a second diode including an anode connected to the first output terminal of the multi-output transformer; and
a first capacitor connected to a cathode of the second diode, the first capacitor being configured to be charged with the turn-on voltage.

6. The fuel cell apparatus according to claim 5, wherein the pre-charging unit includes:
an auxiliary switching unit including an end connected to the second output terminal of the multi-output transformer, the auxiliary switching unit being configured to perform a switching operation in response to a third control signal;
a third diode including an anode connected to another end of the auxiliary switching unit and a cathode connected to the cathode of the first diode; and
a second capacitor connected between the cathode of the third diode and the negative output terminal, and
wherein the main controller is configured to generate the third control signal.

7. The fuel cell apparatus according to claim 4, wherein the buck converter comprises:
a first buck converter configured to step down a level of the voltage stored in the sub-battery to the first level and output a voltage having the first level to the insulated converter;
a second buck converter configured to step down the level of the voltage stored in the sub-battery and output the stepped down voltage; and
a third buck converter configured to step down the level of the voltage stored in the sub-battery to the second level and output a voltage having the second level.

8. The fuel cell apparatus according to claim 7, further comprising:
a low dropout regulator configured to step down the voltage having the second level output from the third buck converter to a voltage having a predetermined level.

9. The fuel cell apparatus according to claim 8, further comprising:
a microcontroller unit configured to generate a pulse width modulated signal by using the stepped down voltage output from the second buck converter and the voltage output from the low dropout regulator.

10. The fuel cell apparatus according to claim 9, wherein the microcontroller unit is further configured to output the pulse width modulated signal to the driving unit.

11. The fuel cell apparatus according to claim 10, wherein the driving unit is further configured to generate the first control signal by using the pulse width modulated signal and the turn-on voltage.

12. A method of controlling a fuel cell apparatus, the method comprising:
outputting a boosted voltage through a first output terminal of a multi-output transformer as a turn-on voltage for charging a first capacitor;
outputting a boosted voltage through a second output terminal of the multi-output transformer as a pre-charging voltage;
switching off a main switching unit connected between a voltage level conversion unit and a main battery and switching on an auxiliary switching unit including an end connected to the second output terminal of the multi-output transformer;
pre-charging an output capacitor connected between a cathode of a first diode and a negative output terminal of a fuel cell, by using the pre-charging voltage charged in a second capacitor;
switching off the auxiliary switching unit;
switching on the main switching unit; and
driving the fuel cell.

13. The method according to claim 12, further comprising stopping operation of an insulated converter including the multi-output transformer.

14. The method according to claim 12, wherein switching off the main switching unit and switching on the auxiliary switching unit comprises:
releasing connection between the output capacitor and the main battery; and
connecting the output capacitor to an insulated converter through a pre-charging unit.

15. The method according to claim 12, wherein pre-charging the output capacitor using the pre-charging voltage charged in the second capacitor comprises:
connecting the output capacitor to a pre-charging unit;
charging the output capacitor with the pre-charging voltage having the same level as a high-voltage battery voltage stored in the main battery;
outputting, by the second output terminal of the multi-output transformer, a voltage as the pre-charging voltage; and
charging the second capacitor with the voltage outputted by the second output terminal of the multi-output transformer.

16. The method according to claim 12, wherein switching off the auxiliary switching unit comprises:
releasing connection between the voltage level conversion unit and an insulated converter.

17. The method according to claim 12, further comprising:
boosting, by the multi-output transformer, a level of a voltage output from a buck converter to the turn-on voltage.

18. The method according to claim 17, further comprising:
lowering, by the buck converter, a level of a voltage stored in a sub-battery to different levels.

19. The method according to claim 12, further comprising:
boosting, by the multi-output transformer, a level of a voltage output from a buck converter to the pre-charging voltage.

20. The method according to claim 19, further comprising:
lowering, by the buck converter, a level of a voltage stored in a sub-battery to different levels.
